(19) United States
(12) Patent Application Publication
(10) Pub. No.: US 2026/0089344 A1
(43) Pub. Date: Mar. 26, 2026

(54) IMAGE ENCODING/DECODING METHOD AND APPARATUS, AND RECORDING MEDIUM STORING BITSTREAM

(71) Applicant: LG Electronics Inc., Seoul (KR)

(72) Inventors: Yongjo AHN, Seoul (KR); Jaehyun LIM, Seoul (KR); Junghak NAM, Seoul (KR)

(21) Appl. No.: 19/111,097

(22) PCT Filed: Sep. 27, 2023
(86) PCT No.: PCT/KR2023/015135

§ 371 Date: Mar. 12, 2025

(30) Foreign Application Priority Data
Sep. 28, 2022 (KR) 10-2022-0123093

(51) Int. Cl. H04N 19/52; H04N 19/132; H04N 19/139; H04N 19/176

(52) U.S. Cl. CPC H04N 19/52; H04N 19/132; H04N 19/139; H04N 19/176

(57) ABSTRACT

An image decoding/encoding method and apparatus, according to the present disclosure, may generate a candidate list for a current block, reorder, on the basis of a certain cost, one or more candidates included in the candidate list, and derive motion information regarding the current block on the basis of the candidate list, so as to perform inter-prediction. In this regard, the cost may be calculated for each of a plurality of candidates included in the candidate list on the basis of at least one of a template matching-based calculation method, a two-way matching-based calculation method, or a motion information-based calculation method.

### TECHNICAL FIELD

The present disclosure relates to an image encoding/decoding method and apparatus, and a recording medium storing a bitstream.

### BACKGROUND ART

Recently, the demand for high-resolution and high-quality images such as HD (High Definition) images and UHD (Ultra High Definition) images has been increasing in various application fields, and accordingly, highly efficient image compression technologies are being discussed.

There are a variety of technologies such as inter-prediction technology that predicts a pixel value included in a current picture from a picture before or after a current picture with video compression technology, intra-prediction technology that predicts a pixel value included in a current picture by using pixel information in a current picture, entropy coding technology that allocates a short sign to a value with high appearance frequency and a long sign to a value with low appearance frequency, etc. and these image compression technologies may be used to effectively compress image data and transmit or store it.

### DISCLOSURE

### Technical Problem

The present disclosure provides a method and apparatus for reordering candidates in a candidate list for inter prediction.

The present disclosure provides a method and apparatus for calculating a cost for reordering a candidate list.

The present disclosure provides a plurality of cost calculation methods for reordering a candidate list, and further provides a method and apparatus for selectively using any one of the plurality of cost calculation methods.

### Technical Solution

An image decoding method and apparatus according to the present disclosure may generate a candidate list of a current block, reorder one or more candidates in the candidate list based on a predetermined cost, derive motion information of the current block based on the candidate list and a candidate index, and perform inter prediction for the current block based on the motion information.

In an image decoding method and device according to the present disclosure, the cost being calculated for each of a plurality of candidates in the candidate list based on at least one of a template matching-based calculation method or a bilateral matching-based calculation method.

In an image decoding method and device according to the present disclosure, one of the template matching-based calculation method or the bilateral matching-based calculation method may be selectively used based on whether the current block satisfies a block size condition.

In an image decoding method and device according to the present disclosure, one of the template matching-based calculation method or the bilateral matching-based calculation method may be selectively used based on whether a candidate belonging to the candidate list satisfies a bidirectional prediction condition.

In an image decoding method and device according to the present disclosure, the bidirectional prediction condition may include at least one of a first condition that motion information of the candidate is motion information for bidirectional prediction, a second condition that one of an L0 reference picture or an L1 reference picture temporally precedes a current picture, and the other temporally follows the current picture, a third condition that a temporal distance between the current picture and the L0 reference picture is the same as a temporal distance between the current picture and the L1 reference picture, a fourth condition that the L0 and L1 reference pictures of the candidate use weighted prediction, or a fifth condition that the L0 and L1 reference pictures of the candidate have the same size as the current picture.

In an image decoding method and device according to the present disclosure, one of the template matching-based calculation method or the bilateral matching-based calculation method may be selectively used based on whether the current block is a block coded in a sub-block mode.

In an image decoding method and device according to the present disclosure, one of the template matching-based calculation method or the bilateral matching-based calculation method may be selectively used based on position information of the current block.

In an image decoding method and device according to the present disclosure, one of the template matching-based calculation method or the bilateral matching-based calculation method may be selectively used based on at least two of whether the current block satisfies a block size condition, whether a candidate of the candidate list satisfies a bidirectional prediction condition, whether the current block is a block coded in a sub-block mode, or position information of the current block.

In an image decoding method and device according to the present disclosure, when the current block satisfies the block size condition and the candidate in the candidate list satisfies the bidirectional prediction condition, the cost may be calculated using the bilateral matching-based calculation method.

In an image decoding method and device according to the present disclosure, when the current block is coded in the sub-block mode and the candidate satisfies the bidirectional prediction condition, the cost may be calculated using the bilateral matching-based calculation method.

In an image decoding method and device according to the present disclosure, when the current block exists at a position where a template area for the template matching-based calculation method is not configured and the candidate satisfies the bidirectional prediction condition, the cost may be calculated using the bilateral matching-based calculation method.

In an image decoding method and device according to the present disclosure, the bilateral matching-based calculation method may calculate the cost using an L0 reference block and an L1 reference block specified based on motion information of a candidate belonging to the candidate list. Herein, the cost may be calculated based on some pixels in the L0 reference block and the L1 reference block.

In an image decoding method and device according to the present disclosure, the some pixels may be determined as a sub-sampled pixel column in the L0 reference block and the L1 reference block, a sub-sampled sub-block in the L0 reference block and the L1 reference block, or a sub-sampled pixel column in the sub-sampled sub-block.

An image encoding method and apparatus according to the present disclosure may generate a candidate list of a current block, reorder one or more candidates in the candidate list based on a predetermined cost, and perform inter prediction for the current block based on the candidate list. Herein, the cost may be calculated for each of a plurality of candidates in the candidate list based on at least one of a template matching-based calculation method or a bilateral matching-based calculation method.

A computer-readable digital storage medium storing encoded video/image information that causes performing the image decoding method by a decoding apparatus according to the present disclosure is provided.

A computer-readable digital storage medium storing video/image information generated according to the image encoding method according to the present disclosure is provided.

A method and a device for transmitting video/image information generated according to an image encoding method according to the present disclosure are provided.

### Advantageous Effects

According to the present disclosure, the encoding efficiency of a candidate index can be improved by reordering one or more candidates belonging to a candidate list.

According to the present disclosure, by adaptively using a bilateral matching-based calculation method or a motion information-based calculation method to calculate the cost, the memory bandwidth required for cost calculation can be reduced.

According to the present disclosure, the complexity of cost calculation can be reduced by selectively using only some pixels of a target block used to calculate a cost for reordering a candidate list.

### DESCRIPTION OF DRAWINGS

FIG. 1 shows a video/image coding system according to the present disclosure.

FIG. 2 shows a schematic block diagram of an encoding apparatus to which an embodiment of the present disclosure is applicable and encoding of video/image signals is performed.

FIG. 3 shows a schematic block diagram of a decoding apparatus to which an embodiment of the present disclosure is applicable and decoding of video/image signals is performed.

FIG. 4 shows an inter prediction method performed by a decoding device as an embodiment according to the present disclosure.

FIG. 5 shows a schematic configuration of an inter predictor 332 performing an inter prediction method according to the present disclosure.

FIG. 6 shows an inter prediction method performed by an encoding device as an embodiment according to the present disclosure.

FIG. 7 shows a schematic configuration of an inter predictor 221 performing an inter prediction method according to the present disclosure.

FIG. 8 shows an example of a contents streaming system to which embodiments of the present disclosure may be applied.

### BEST MODE

Since the present disclosure may make various changes and have several embodiments, specific embodiments will be illustrated in a drawing and described in detail in a detailed description. However, it is not intended to limit the present disclosure to a specific embodiment, and should be understood to include all changes, equivalents and substitutes included in the spirit and technical scope of the present disclosure. While describing each drawing, similar reference numerals are used for similar components.

A term such as first, second, etc. may be used to describe various components, but the components should not be limited by the terms. The terms are used only to distinguish one component from other components. For example, a first component may be referred to as a second component without departing from the scope of a right of the present disclosure, and similarly, a second component may also be referred to as a first component. A term of and/or includes any of a plurality of related stated items or a combination of a plurality of related stated items.

When a component is referred to as “being connected” or “being linked” to another component, it should be understood that it may be directly connected or linked to another component, but another component may exist in the middle. On the other hand, when a component is referred to as “being directly connected” or “being directly linked” to another component, it should be understood that there is no another component in the middle.

A term used in this application is just used to describe a specific embodiment, and is not intended to limit the present disclosure. Singular expressions include plural expressions unless the context clearly dictates otherwise. In this application, it should be understood that a term such as “include” or “have”, etc. is intended to designate the presence of features, numbers, steps, operations, components, parts or combinations thereof described in the specification, but does not exclude in advance the possibility of presence or addition of one or more other features, numbers, steps, operations, components, parts or combinations thereof.

The present disclosure relates to video/image coding. For example, a method/an embodiment disclosed herein may be applied to a method disclosed in the versatile video coding (VVC) standard. In addition, a method/an embodiment disclosed herein may be applied to a method disclosed in the essential video coding (EVC) standard, the AOMedia Video 1 (AV1) standard, the 2nd generation of audio video coding standard (AVS2) or the next-generation video/image coding standard (ex.H.267 or H.268, etc.).

This specification proposes various embodiments of video/image coding, and unless otherwise specified, the embodiments may be performed in combination with each other.

Herein, a video may refer to a set of a series of images over time. A picture generally refers to a unit representing one image in a specific time period, and a slice/a tile is a unit that forms part of a picture in coding. A slice/a tile may include at least one coding tree unit (CTU). One picture may consist of at least one slice/tile. One tile is a rectangular region composed of a plurality of CTUs within a specific tile column and a specific tile row of one picture. A tile column is a rectangular region of CTUs having the same height as that of a picture and a width designated by a syntax requirement of a picture parameter set. A tile row is a rectangular region of CTUs having a height designated by a picture parameter set and the same width as that of a picture. CTUs within one tile may be arranged consecutively according to CTU raster scan, while tiles within one picture may be arranged consecutively according to raster scan of a tile. One slice may include an integer number of complete tiles or an integer number of consecutive complete CTU rows within a tile of a picture that may be included exclusively in a single NAL unit. Meanwhile, one picture may be divided into at least two sub-pictures. A sub-picture may be a rectangular region of at least one slice within a picture.

A pixel, a pixel or a pel may refer to the minimum unit that constitutes one picture (or image). In addition, ‘sample’ may be used as a term corresponding to a pixel. A sample may generally represent a pixel or a pixel value, and may represent only a pixel/a pixel value of a luma component, or only a pixel/a pixel value of a chroma component.

A unit may represent a basic unit of image processing. A unit may include at least one of a specific region of a picture and information related to a corresponding region. One unit may include one luma block and two chroma (ex. cb, cr) blocks. In some cases, a unit may be used interchangeably with a term such as a block or an region, etc. In a general case, a M×N block may include a set (or an array) of transform coefficients or samples (or sample arrays) consisting of M columns and N rows.

Herein, “A or B” may refer to “only A”, “only B” or “both A and B.” In other words, herein, “A or B” may be interpreted as “A and/or B.” For example, herein, “A, B or C” may refer to “only A”, “only B”, “only C” or “any combination of A, B and C)”.

A slash (/) or a comma used herein may refer to “and/or.” For example, “A/B” may refer to “A and/or B.” Accordingly, “A/B” may refer to “only A”, “only B” or “both A and B.” For example, “A, B, C” may refer to “A, B, or C”.

Herein, “at least one of A and B” may refer to “only A”, “only B” or “both A and B”. In addition, herein, an expression such as “at least one of A or B” or “at least one of A and/or B” may be interpreted in the same way as “at least one of A and B”.

In addition, herein, “at least one of A, B and C” may refer to “only A”, “only B”, “only C”, or “any combination of A, B and C”. In addition, “at least one of A, B or C” or “at least one of A, B and/or C” may refer to “at least one of A, B and C”.

In addition, a parenthesis used herein may refer to “for example.” Specifically, when indicated as “prediction (intra prediction)”, “intra prediction” may be proposed as an example of “prediction”. In other words, “prediction” herein is not limited to “intra prediction” and “intra prediction” may be proposed as an example of “prediction.” In addition, even when indicated as “prediction (i.e., intra prediction)”, “intra prediction” may be proposed as an example of “prediction.”

Herein, a technical feature described individually in one drawing may be implemented individually or simultaneously.

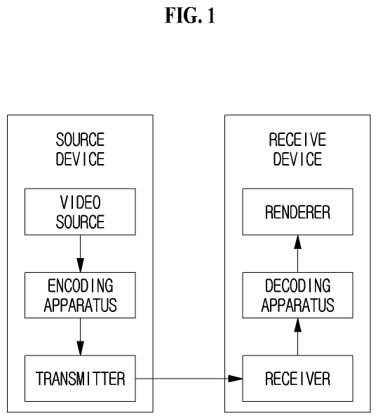

FIG. 1 shows a video/image coding system according to the present disclosure.

Referring to FIG. 1, a video/image coding system may include a first device (a source device) and a second device (a receiving device).

A source device may transmit encoded video/image information or data in a form of a file or streaming to a receiving device through a digital storage medium or a network. The source device may include a video source, an encoding apparatus and a transmission unit. The receiving device may include a reception unit, a decoding apparatus and a renderer. The encoding apparatus may be referred to as a video/image encoding apparatus and the decoding apparatus may be referred to as a video/image decoding apparatus. A transmitter may be included in an encoding apparatus. A receiver may be included in a decoding apparatus. A renderer may include a display unit, and a display unit may be composed of a separate device or an external component.

A video source may acquire a video/an image through a process of capturing, synthesizing or generating a video/an image. A video source may include a device of capturing a video/an image and a device of generating a video/an image. A device of capturing a video/an image may include at least one camera, a video/image archive including previously captured videos/images, etc. A device of generating a video/an image may include a computer, a tablet, a smartphone, etc. and may (electronically) generate a video/an image. For example, a virtual video/image may be generated through a computer, etc., and in this case, a process of capturing a video/an image may be replaced by a process of generating related data.

An encoding apparatus may encode an input video/image. An encoding apparatus may perform a series of procedures such as prediction, transform, quantization, etc. for compression and coding efficiency. Encoded data (encoded video/image information) may be output in a form of a bitstream.

A transmission unit may transmit encoded video/image information or data output in a form of a bitstream to a reception unit of a receiving device through a digital storage medium or a network in a form of a file or streaming. A digital storage medium may include various storage media such as USB, SD, CD, DVD, Blu-ray, HDD, SSD, etc. A transmission unit may include an element for generating a media file through a predetermined file format and may include an element for transmission through a broadcasting/communication network. A reception unit may receive/extract the bitstream and transmit it to a decoding apparatus.

A decoding apparatus may decode a video/an image by performing a series of procedures such as dequantization, inverse transform, prediction, etc. corresponding to an operation of an encoding apparatus.

A renderer may render a decoded video/image. A rendered video/image may be displayed through a display unit.

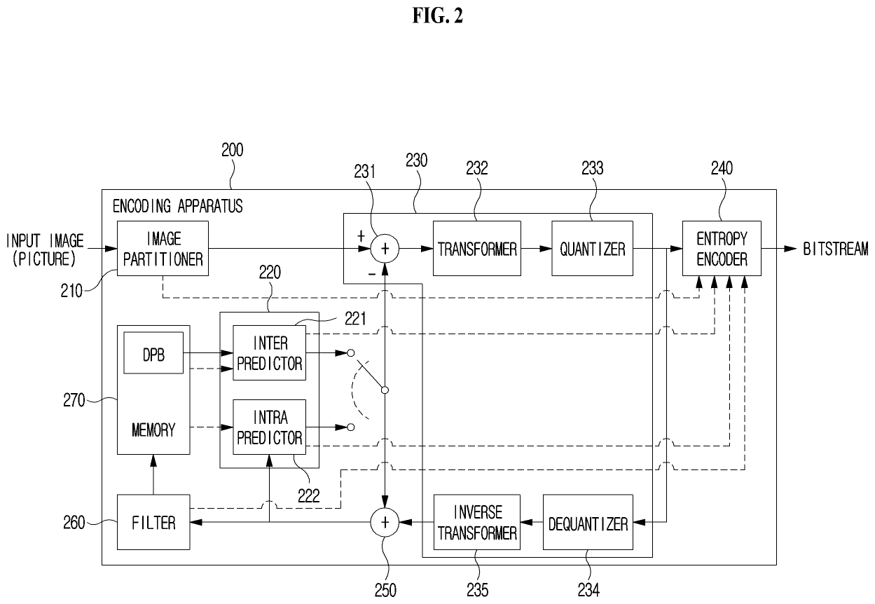

FIG. 2 shows a rough block diagram of an encoding apparatus to which an embodiment of the present disclosure may be applied and encoding of a video/image signal is performed.

Referring to FIG. 2, an encoding apparatus 200 may be composed of an image partitioner 210, a predictor 220, a residual processor 230, an entropy encoder 240, an adder 250, a filter 260 and a memory 270. A predictor 220 may include an inter predictor 221 and an intra predictor 222. A residual processor 230 may include a transformer 232, a quantizer 233, a dequantizer 234 and an inverse transformer 235. A residual processor 230 may further include a subtractor 231. An adder 250 may be referred to as a reconstructor or a reconstructed block generator. The above-described image partitioner 210, predictor 220, residual processor 230, entropy encoder 240, adder 250 and filter 260 may be configured by at least one hardware component (e.g., an encoder chipset or a processor) according to an embodiment. In addition, a memory 270 may include a decoded picture buffer (DPB) and may be configured by a digital storage medium. The hardware component may further include a memory 270 as an internal/external component.

An image partitioner 210 may partition an input image (or picture, frame) input to an encoding apparatus 200 into at least one processing unit. As an example, the processing unit may be referred to as a coding unit (CU). In this case, a coding unit may be partitioned recursively according to a quad-tree binary-tree ternary-tree (QTBTTT) structure from a coding tree unit (CTU) or the largest coding unit (LCU).

For example, one coding unit may be partitioned into a plurality of coding units with a deeper depth based on a quad tree structure, a binary tree structure and/or a ternary structure. In this case, for example, a quad tree structure may be applied first and a binary tree structure and/or a ternary structure may be applied later. Alternatively, a binary tree structure may be applied before a quad tree structure. A coding procedure according to this specification may be performed based on a final coding unit that is no longer partitioned. In this case, based on coding efficiency, etc. according to an image characteristic, the largest coding unit may be directly used as a final coding unit, or if necessary, a coding unit may be recursively partitioned into coding units of a deeper depth, and a coding unit with an optimal size may be used as a final coding unit. Here, a coding procedure may include a procedure such as prediction, transform, and reconstruction, etc. described later.

As another example, the processing unit may further include a prediction unit (PU) or a transform unit (TU). In this case, the prediction unit and the transform unit may be divided or partitioned from a final coding unit described above, respectively. The prediction unit may be a unit of sample prediction, and the transform unit may be a unit for deriving a transform coefficient and/or a unit for deriving a residual signal from a transform coefficient.

In some cases, a unit may be used interchangeably with a term such as a block or an region, etc. In a general case, a M×N block may represent a set of transform coefficients or samples consisting of M columns and N rows. A sample may generally represent a pixel or a pixel value, and may represent only a pixel/a pixel value of a luma component, or only a pixel/a pixel value of a chroma component. A sample may be used as a term that makes one picture (or image) correspond to a pixel or a pel.

An encoding apparatus 200 may subtract a prediction signal (a prediction block, a prediction sample array) output from an inter predictor 221 or an intra predictor 222 from an input image signal (an original block, an original sample array) to generate a residual signal (a residual signal, a residual sample array), and a generated residual signal is transmitted to a transformer 232. In this case, a unit that subtracts a prediction signal (a prediction block, a prediction sample array) from an input image signal (an original block, an original sample array) within an encoding apparatus 200 may be referred to as a subtractor 231.

A predictor 220 may perform prediction on a block to be processed (hereinafter, referred to as a current block) and generate a predicted block including prediction samples for the current block. A predictor 220 may determine whether intra prediction or inter prediction is applied in a unit of a current block or a CU. A predictor 220 may generate various information on prediction such as prediction mode information, etc. and transmit it to an entropy encoder 240 as described later in a description of each prediction mode. Information on prediction may be encoded in an entropy encoder 240 and output in a form of a bitstream.

An intra predictor 222 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. A nondirectional mode may include at least one of a DC mode or a planar mode. A directional mode may include 33 directional modes or 65 directional modes according to a detail level of a prediction direction. However, it is an example, and more or less directional modes may be used according to a configuration. An intra predictor 222 may determine a prediction mode applied to a current block by using a prediction mode applied to a neighboring block.

An inter predictor 221 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. A reference picture including the reference block and a reference picture including the temporal neighboring block may be the same or different. The temporal neighboring block may be referred to as a collocated reference block, a collocated CU (colCU), etc., and a reference picture including the temporal neighboring block may be referred to as a collocated picture (colPic). For example, an inter predictor 221 may configure a motion information candidate list based on neighboring blocks and generate information indicating which candidate is used to derive a motion vector and/or a reference picture index of the current block. Inter prediction may be performed based on various prediction modes, and for example, for a skip mode and a merge mode, an inter predictor 221 may use motion information of a neighboring block as motion information of a current block. For a skip mode, unlike a merge mode, a residual signal may not be transmitted. For a motion vector prediction (MVP) mode, a motion vector of a neighboring block is used as a motion vector predictor and a motion vector difference is signaled to indicate a motion vector of a current block.

A predictor 220 may generate a prediction signal based on various prediction methods described later. For example, a predictor may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, a sample value within a picture may be signaled based on information on a palette table and a palette index. A prediction signal generated through the predictor 220 may be used to generate a reconstructed signal or a residual signal.

A transformer 232 may generate transform coefficients by applying a transform technique to a residual signal. For example, a transform technique may include at least one of Discrete Cosine Transform (DCT), Discrete Sine Transform (DST), Karhunen-Loève Transform (KLT), Graph-Based Transform (GBT) or Conditionally Non-linear Transform (CNT). Here, GBT refers to transform obtained from this graph when relationship information between pixels is expressed as a graph. CNT refers to transform obtained based on generating a prediction signal by using all previously reconstructed pixels. In addition, a transform process may be applied to a square pixel block in the same size or may be applied to a non-square block in a variable size.

A quantizer 233 may quantize transform coefficients and transmit them to an entropy encoder 240 and an entropy encoder 240 may encode a quantized signal (information on quantized transform coefficients) and output it as a bitstream. Information on the quantized transform coefficients may be referred to as residual information. A quantizer 233 may rearrange quantized transform coefficients in a block form into an one-dimensional vector form based on coefficient scan order, and may generate information on the quantized transform coefficients based on the quantized transform coefficients in the one-dimensional vector form.

An entropy encoder 240 may perform various encoding methods such as exponential Golomb, context-adaptive variable length coding (CAVLC), context-adaptive binary arithmetic coding (CABAC), etc. An entropy encoder 240 may encode information necessary for video/image reconstruction (e.g., a value of syntax elements, etc.) other than quantized transform coefficients together or separately.

Encoded information (ex. encoded video/image information) may be transmitted or stored in a unit of a network abstraction layer (NAL) unit in a bitstream form. The video/image information may further include information on various parameter sets such as an adaptation parameter set (APS), a picture parameter set (PPS), a sequence parameter set (SPS) or a video parameter set (VPS), etc. In addition, the video/image information may further include general constraint information. Herein, information and/or syntax elements transmitted/signaled from an encoding apparatus to a decoding apparatus may be included in video/image information. The video/image information may be encoded through the above-described encoding procedure and included in the bitstream. The bitstream may be transmitted through a network or may be stored in a digital storage medium. Here, a network may include a broadcasting network and/or a communication network, etc. and a digital storage medium may include various storage media such as USB, SD, CD, DVD, Blu-ray, HDD, SSD, etc. A transmission unit (not shown) for transmitting and/or a storage unit (not shown) for storing a signal output from an entropy encoder 240 may be configured as an internal/external element of an encoding apparatus 200, or a transmission unit may be also included in an entropy encoder 240.

Quantized transform coefficients output from a quantizer 233 may be used to generate a prediction signal. For example, a residual signal (a residual block or residual samples) may be reconstructed by applying dequantization and inverse transform to quantized transform coefficients through a dequantizer 234 and an inverse transformer 235. An adder 250 may add a reconstructed residual signal to a prediction signal output from an inter predictor 221 or an intra predictor 222 to generate a reconstructed signal (a reconstructed picture, a reconstructed block, a reconstructed sample array). When there is no residual for a block to be processed like when a skip mode is applied, a predicted block may be used as a reconstructed block. An adder 250 may be referred to as a reconstructor or a reconstructed block generator. A generated reconstructed signal may be used for intra prediction of a next block to be processed within a current picture, and may be also used for inter prediction of a next picture through filtering as described later. Meanwhile, luma mapping with chroma scaling (LMCS) may be applied in a picture encoding and/or reconstruction process.

A filter 260 may improve subjective/objective image quality by applying filtering to a reconstructed signal. For example, a filter 260 may generate a modified reconstructed picture by applying various filtering methods to a reconstructed picture, and may store the modified reconstructed picture in a memory 270, specifically in a DPB of a memory 270. The various filtering methods may include deblocking filtering, sample adaptive offset, adaptive loop filter, bilateral filter, etc. A filter 260 may generate various information on filtering and transmit it to an entropy encoder 240. Information on filtering may be encoded in an entropy encoder 240 and output in a form of a bitstream.

A modified reconstructed picture transmitted to a memory 270 may be used as a reference picture in an inter predictor 221. When inter prediction is applied through it, an encoding apparatus may avoid prediction mismatch in an encoding apparatus 200 and a decoding apparatus, and may also improve encoding efficiency.

A DPB of a memory 270 may store a modified reconstructed picture to use it as a reference picture in an inter predictor 221. A memory 270 may store motion information of a block from which motion information in a current picture is derived (or encoded) and/or motion information of blocks in a pre-reconstructed picture. The stored motion information may be transmitted to an inter predictor 221 to be used as motion information of a spatial neighboring block or motion information of a temporal neighboring block. A memory 270 may store reconstructed samples of reconstructed blocks in a current picture and transmit them to an intra predictor 222.

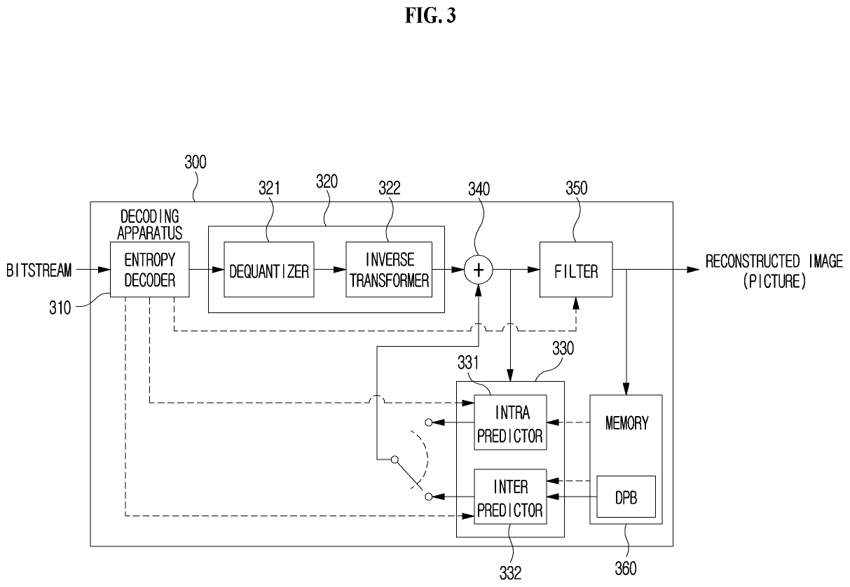

FIG. 3 shows a rough block diagram of a decoding apparatus to which an embodiment of the present disclosure may be applied and decoding of a video/image signal is performed.

Referring to FIG. 3, a decoding apparatus 300 may be configured by including an entropy decoder 310, a residual processor 320, a predictor 330, an adder 340, a filter 350 and a memory 360. A predictor 330 may include an inter predictor 331 and an intra predictor 332. A residual processor 320 may include a dequantizer 321 and an inverse transformer 321.

According to an embodiment, the above-described entropy decoder 310, residual processor 320, predictor 330, adder 340 and filter 350 may be configured by one hardware component (e.g., a decoder chipset or a processor). In addition, a memory 360 may include a decoded picture buffer (DPB) and may be configured by a digital storage medium. The hardware component may further include a memory 360 as an internal/external component.

When a bitstream including video/image information is input, a decoding apparatus 300 may reconstruct an image in response to a process in which video/image information is processed in an encoding apparatus of FIG. 2. For example, a decoding apparatus 300 may derive units/blocks based on block partition-related information obtained from the bitstream. A decoding apparatus 300 may perform decoding by using a processing unit applied in an encoding apparatus. Accordingly, a processing unit of decoding may be a coding unit, and a coding unit may be partitioned from a coding tree unit or the largest coding unit according to a quad tree structure, a binary tree structure and/or a ternary tree structure. At least one transform unit may be derived from a coding unit. And, a reconstructed image signal decoded and output through a decoding apparatus 300 may be played through a playback device.

A decoding apparatus 300 may receive a signal output from an encoding apparatus of FIG. 2 in a form of a bitstream, and a received signal may be decoded through an entropy decoder 310. For example, an entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS) or a video parameter set (VPS), etc. In addition, the video/image information may further include general constraint information. A decoding apparatus may decode a picture further based on information on the parameter set and/or the general constraint information. Signaled/received information and/or syntax elements described later herein may be decoded through the decoding procedure and obtained from the bitstream. For example, an entropy decoder 310 may decode information in a bitstream based on a coding method such as exponential Golomb encoding, CAVLC, CABAC, etc. and output a value of a syntax element necessary for image reconstruction and quantized values of a transform coefficient regarding a residual. In more detail, a CABAC entropy decoding method may receive a bin corresponding to each syntax element from a bitstream, determine a context model by using syntax element information to be decoded, decoding information of a neighboring block and a block to be decoded or information of a symbol/a bin decoded in a previous step, perform arithmetic decoding of a bin by predicting a probability of occurrence of a bin according to a determined context model and generate a symbol corresponding to a value of each syntax element. In this case, a CABAC entropy decoding method may update a context model by using information on a decoded symbol/bin for a context model of a next symbol/bin after determining a context model. Among information decoded in an entropy decoder 310, information on prediction is provided to a predictor (an inter predictor 332 and an intra predictor 331), and a residual value on which entropy decoding was performed in an entropy decoder 310, i.e., quantized transform coefficients and related parameter information may be input to a residual processor 320. A residual processor 320 may derive a residual signal (a residual block, residual samples, a residual sample array). In addition, information on filtering among information decoded in an entropy decoder 310 may be provided to a filter 350. Meanwhile, a reception unit (not shown) that receives a signal output from an encoding apparatus may be further configured as an internal/external element of a decoding apparatus 300 or a reception unit may be a component of an entropy decoder 310.

Meanwhile, a decoding apparatus according to this specification may be referred to as a video/image/picture decoding apparatus, and the decoding apparatus may be divided into an information decoder (a video/image/picture information decoder) and a sample decoder (a video/image/picture sample decoder). The information decoder may include the entropy decoder 310 and the sample decoder may include at least one of dequantizer 321, the inverse transformer 322, the adder 340, the filter 350, the memory 360, the inter predictor 332 and the intra predictor 331.

A dequantizer 321 may dequantize quantized transform coefficients and output transform coefficients. A dequantizer 321 may rearrange quantized transform coefficients into a two-dimensional block form. In this case, the rearrangement may be performed based on coefficient scan order performed in an encoding apparatus. A dequantizer 321 may perform dequantization on quantized transform coefficients by using a quantization parameter (e.g., quantization step size information) and obtain transform coefficients.

An inverse transformer 322 inversely transforms transform coefficients to obtain a residual signal (a residual block, a residual sample array).

A predictor 320 may perform prediction on a current block and generate a predicted block including prediction samples for the current block. A predictor 320 may determine whether intra prediction or inter prediction is applied to the current block based on the information on prediction output from an entropy decoder 310 and determine a specific intra/inter prediction mode.

A predictor 320 may generate a prediction signal based on various prediction methods described later. For example, a predictor 320 may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, information on a palette table and a palette index may be included in the video/image information and signaled.

An intra predictor 331 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. An intra predictor 331 may determine a prediction mode applied to a current block by using a prediction mode applied to a neighboring block.

An inter predictor 332 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. For example, an inter predictor 332 may configure a motion information candidate list based on neighboring blocks and derive a motion vector and/or a reference picture index of the current block based on received candidate selection information. Inter prediction may be performed based on various prediction modes, and the information on prediction may include information indicating an inter prediction mode for the current block.

An adder 340 may add an obtained residual signal to a prediction signal (a prediction block, a prediction sample array) output from a predictor (including an inter predictor 332 and/or an intra predictor 331) to generate a reconstructed signal (a reconstructed picture, a reconstructed block, a reconstructed sample array). When there is no residual for a block to be processed like when a skip mode is applied, a prediction block may be used as a reconstructed block.

An adder 340 may be referred to as a reconstructor or a reconstructed block generator. A generated reconstructed signal may be used for intra prediction of a next block to be processed in a current picture, may be output through filtering as described later or may be used for inter prediction of a next picture. Meanwhile, luma mapping with chroma scaling (LMCS) may be applied in a picture decoding process.

A filter 350 may improve subjective/objective image quality by applying filtering to a reconstructed signal. For example, a filter 350 may generate a modified reconstructed picture by applying various filtering methods to a reconstructed picture and transmit the modified reconstructed picture to a memory 360, specifically a DPB of a memory 360. The various filtering methods may include deblocking filtering, sample adaptive offset, adaptive loop filter, bilateral filter, etc.

The (modified) reconstructed picture stored in the DPB of the memory 360 can be used as a reference picture in the inter predictor 332. A memory 360 may store motion information of a block from which motion information in a current picture is derived (or decoded) and/or motion information of blocks in a pre-reconstructed picture. The stored motion information may be transmitted to an inter predictor 260 to be used as motion information of a spatial neighboring block or motion information of a temporal neighboring block. A memory 360 may store reconstructed samples of reconstructed blocks in a current picture and transmit them to an intra predictor 331.

Herein, embodiments described in a filter 260, an inter predictor 221 and an intra predictor 222 of an encoding apparatus 200 may be also applied equally or correspondingly to a filter 350, an inter predictor 332 and an intra predictor 331 of a decoding apparatus 300, respectively.

FIG. 4 shows an inter prediction method performed by a decoding device as an embodiment according to the present disclosure.

Referring to FIG. 4, a candidate list for predicting/deriving motion information of a current block may be generated (S400).

The motion information of the current block may include at least one of a motion vector, a reference picture index, inter prediction direction information, or weight information for bidirectional weighted prediction.

A candidate list for predicting/deriving motion information of a current block may be for a merge mode or an advanced motion vector prediction mode (AMVP mode). However, it is not limited thereto, and the candidate list may also be for an affine merge mode or an affine inter mode. A candidate list of a merge mode for motion merging may be referred to as a merge candidate list. A candidate list of an AMVP mode for motion prediction may be referred to as a prediction candidate list.

The candidate list may include a plurality of candidates, and the plurality of candidates may include at least one of a spatial candidate or a temporal candidate. Here, the motion information of the spatial candidate may be derived based on the motion information of a neighboring block spatially adjacent to the current block (hereinafter, referred to as a spatial neighboring block). The spatial neighboring block may include at least one of the top neighboring block, the left neighboring block, the bottom-left neighboring block, the top-right neighboring block, or the top-left neighboring block of the current block. The motion information of the temporal candidate may be derived based on the motion information of the neighboring block temporally adjacent to the current block (hereinafter referred to as the temporal neighboring block). The temporal neighboring block may be a block that belongs to a reference picture (collocated picture) decoded before the current picture and is the collocated block as the current block. The collocated block may be a block that includes at least one of the position of the top-left sample of the current block, the position of the center sample, or the position of the sample adjacent to the bottom-right corner of the current block.

Referring to FIG. 4, one or more candidates in a candidate list may be reordered based on a predetermined cost (S410).

The reordering according to the present disclosure may refer to changing the position of a candidate in the candidate list or changing the candidate index assigned to the candidate. To this end, a cost for reordering may be calculated for each candidate in the candidate list. The candidates may be reordered in ascending or descending order of the calculated costs to generate a final candidate list.

The cost according to the present disclosure may be calculated based on at least one of a template matching (TM)-based calculation method, a bilateral matching (BM)-based calculation method, or a motion information-based calculation method, which will be described in detail below.

### Template Matching-Based Calculation Method

The template matching-based cost may be calculated as the cost between the template region of the current block and the template region of the reference block. Here, the cost may refer to SAD (sum of absolute difference), SATD (sum of absolute transformed difference), or SSE (sum of square error).

The template region of the current block may include at least one of a left neighboring region or a top neighboring region adjacent to the current block. For example, the template region of the current block may include a left neighboring region adjacent to the current block and may not include a top neighboring region. Alternatively, the template region of the current block may include a top neighboring region adjacent to the current block and may not include a left neighboring region. Alternatively, the template region of the current block may include top and left neighboring regions adjacent to the current block.

The template region of the reference block may be configured to correspond to the template region of the current block. That is, the template region of the reference block may include at least one of a left neighboring region or a top neighboring region adjacent to the reference block. Here, the reference block may be specified based on motion information of a candidate belonging to a candidate list of the current block. For example, within the reference picture of the candidate, a block at a position moved by the motion vector of the candidate from the position of the current block may be determined as the reference block. Alternatively, within the reference picture of the candidate, a block at a position moved by the motion vector of the candidate from the position of a spatial/temporal neighboring block corresponding to the candidate may be determined as the reference block.

When the motion information of the candidate is motion information for bidirectional prediction, a reference block of reference picture list 0 (hereinafter referred to as L0 reference block) and a reference block of reference picture list 1 (hereinafter referred to as L1 reference block) may be specified respectively. In this case, a cost between a template region of at least one of the L0 reference block or L1 reference block and the template region of the current block may be calculated.

For example, a first cost between the template region of the L0 reference block and the template region of the current block may be calculated, and a second cost between the template region of the L1 reference block and the template region of the current block may be calculated. A final cost may be calculated based on a weighted average of the first cost and the second cost. A weight for the weighted average may be derived based on a temporal distance between the L0 reference picture to which the L0 reference block belongs and the current picture to which the current block belongs and a temporal distance between the L1 reference picture to which the L1 reference block belongs and the current picture. Here, the temporal distance may be defined as a difference in output order (picture order count, POC).

Alternatively, a first cost between the template region of the L0 reference block and the template region of the current block may be calculated, and a second cost between the template region of the L1 reference block and the template region of the current block may be calculated. The final cost may be calculated based on the maximum or minimum value of the first cost and the second cost.

Alternatively, a combined template region may be configured by a weighted average between a sample of the template region of the L0 reference block and a sample of the template region of the L1 reference block, and a cost between the combined template region and the template region of the current block may be calculated. Here, the weighted average is as described above.

Alternatively, the cost may be calculated based on the template region of one of the L0 reference block or the L1 reference block, and not based on the template region of the other. In this case, the cost may be limited to being calculated based only on the template region of the L0 reference block, or based only on the template region of the L1 reference block. Alternatively, a reference picture having a close temporal distance from the current picture among the L0 reference picture and the L1 reference picture may be selected, and the cost may be calculated based on the template region of the reference block belonging to the selected reference picture. When a template matching-based calculation method is used, a candidate having a smaller cost may have similar motion information to the current block, and it is advantageous from the encoding perspective to assign a small candidate index to such a candidate. Accordingly, the candidates may be reordered in ascending order of the calculated costs.

### Bilateral Matching (BM)-Based Calculation Method

The bilateral matching-based cost may be calculated as the cost between the L0 reference block and the L1 reference block. Here, the cost may refer to the sum of absolute difference (SAD), the sum of absolute transformed difference (SATD), or the sum of square error (SSE).

The L0/L1 reference block may be specified based on the motion information of the candidate belonging to the candidate list of the current block. For example, within the reference picture of the candidate, a block at a position moved by the L0 motion vector of the candidate from the position of the current block may be determined as the L0 reference block. Within the reference picture of the candidate, a block at a position moved by the L1 motion vector of the candidate from the position of the current block may be determined as the L1 reference block. Alternatively, within the reference picture of the candidate, a block at a position moved by the L0 motion vector of the candidate from a position of a spatial/temporal neighboring block corresponding to the candidate may be determined as an L0 reference block. Within the reference picture of the candidate, a block at a position moved by the L1 motion vector of the candidate from a position of a spatial/temporal neighboring block corresponding to the candidate may be determined as an L1 reference block.

The bilateral matching-based cost may be calculated based on a predetermined bidirectional prediction condition being satisfied. For example, the bidirectional prediction condition may include at least one of conditions 1 to 5 described below.
(Condition 1) The motion information of the candidate is motion information for bidirectional prediction.
(Condition 2) One of the L0 reference picture to which the L0 reference block belongs and the L1 reference picture to which the L1 reference block belongs temporally precedes the current picture, and the other temporally follows the current picture. That is, Condition 2 is related to the temporal order of the L0 reference picture and the L1 reference picture of the candidate. Here, the temporal order may refer to the output order (picture order count, POC). For example, the POC of one of the L0 reference picture and the L1 reference picture is less than the POC of the current picture, and the POC of the other is greater than the POC of the current picture.
(Condition 3) The temporal distance between the current picture and the L0 reference picture is the same as the temporal distance between the current picture and the L1 reference picture. Here, the temporal distance may refer to the difference in output order (picture order count, POC).
(Condition 4) The L0/L1 reference pictures of the candidate do not use weighted prediction. Alternatively, the weight for weighted prediction applied to the L0 reference picture of the candidate is different from the weight for weighted prediction applied to the L1 reference picture of the candidate.
(Condition 5) The size of the L0/L1 reference picture of the candidate is the same as the size of the current picture.

When a bilateral matching-based calculation method is used, a candidate with a smaller cost may have similar motion information to the current block. It is advantageous from an encoding perspective to assign a small candidate index to such a candidate. Accordingly, the candidates may reordered in ascending order of the calculated costs.

### Motion Information-Based Calculation Method

The motion information-based cost may be calculated as the similarity between the motion information of a candidate in the candidate list and the motion information of a reference location that is spatially/temporally adjacent to the current block.

Motion information may exist in reference blocks that belong to an area spatially/temporally adjacent to the current block and have a predetermined size. The similarity may be calculated by comparing the motion information of reference blocks spatially/temporally adjacent to the current block with the motion information of a candidate belonging to the candidate list. Here, the reference block may refer to an encoding/decoding unit such as a coding block, a prediction block, or a transform block. Alternatively, the reference block may be a block having a predetermined size regardless of the size of the encoding/decoding unit. In this case, the block having a predetermined size may refer to a block having a pre-defined size such as 4×4, 8×8, or 16×16 and may be a unit that stores motion information as a block having a pre-defined size such as 4×4, 8×8, or 16×16.

For example, a motion information buffer may be configured in the form of a one-dimensional array based on motion information of reference blocks spatially/temporally adjacent to the current block. A total of K motion vector fields (MVFs) may be configured in the motion information buffer. The cost between the motion vector of a candidate in the candidate list and the K motion vector fields may be calculated as shown in the following equation 1.

$$cost ( n ) = {\sum }_{k = 0}^{K - 1} eq ( {mvp}_{n} , {mvf}_{k} ) \qquad [ Equation 1 ]$$

In equation 1, cost(n) represents the cost of the n-th candidate in the candidate list of the current block. mvpₙ represents the motion vector of the n-th candidate, and mvfₖ represents the k-th motion vector field. eq(mvpₙ,mvfₖ) is a function for calculating the similarity between the motion vector of the candidate and the motion vector field, and may be defined as in the following equation 2.

$$eq ( {mvp}_{n} , {mvf}_{k} ) = \{ \begin{matrix}\partial , & if {mvp}_{n} = {mvf}_{k} \\ 0 , & otherwise\end{matrix} , \qquad [ Equation 2 ]$$

Referring to equation 2, when the motion vector of the n-th candidate and the k-th motion vector field are the same, a predefined value ∂ may be output. The value of ∂ may be a positive real number or integer. On the other hand, when the motion vector of the n-th candidate and the k-th motion vector field are not the same, a predefined value 0 may be output.

Alternatively, eq(mvpₙ,mvfₖ) of equation 1 may be defined as the following equation 3.

$$eq ( {mvp}_{n} , {mvf}_{k} ) = \{ \begin{matrix}\partial , & if ( {mvp}_{n} + offset ) >> shift = ( {mvf}_{k} + offset ) >> shift \\ 0 , & otherwise\end{matrix} , \qquad [ Equation 3 ]$$

Referring to equation 3, when the motion vector of the n-th candidate and the k-th motion vector field are the same within a pre-defined precision, a pre-defined value ∂ may be output. The value of ∂ may be a positive real number or integer. Otherwise, a pre-defined value 0 may be output. In equation 3, shift is an integer such as 1, 2, 3, or 4, and shift may be variable based on the size of the block. Offset is a round offset according to the shift, and may be an integer having a value such as 1, 2, 4, or 8 based on the shift.

Alternatively, the process of configuring a motion information buffer in the form of a one-dimensional array based on the motion information of the spatially/temporally adjacent reference blocks may be omitted. In this case, the cost may be calculated as in the following equation 4 by using a motion information buffer in the form of a two-dimensional array configured around the current block.

$$cost ( n ) = {\sum }_{i = 0}^{I - 1} {eq}_{x} ( {mvp}_{n} , {mvf}_{i} ) + {\sum }_{j = 0}^{J - 1} {eq}_{y} ( {mvp}_{n} , {mvf}_{j} ) \qquad [ Equation 4 ]$$

In equation 4, cost(n) represents the cost for the n-th candidate in the candidate list of the current block. i represents the index of the reference blocks in the x-axis direction located at the top of the current block, and j represents the index of the reference blocks in the y-axis direction located at the left of the current block. eqₓ(mvpₙ,mvfᵢ) and eq_{y}(mvpₙ,mvfⱼ) are functions for calculating the similarity between the motion vector of the n-th candidate and the motion vector field, and may be defined as in the following equations 5 and 6, respectively.

$${eq}_{x} ( {mvp}_{n} , {mvf}_{i} ) = \{ \begin{matrix}\partial , & if {mvp}_{n} = {mvf}_{i} \\ 0 , & otherwise\end{matrix} , \qquad [ Equation 5 ]$$

$${eq}_{y} ( {mvp}_{n} , {mvf}_{j} ) = \{ \begin{matrix}\partial , & if {mvp}_{n} = {mvf}_{j} \\ 0 , & otherwise\end{matrix} , \qquad [ Equation 6 ]$$

Referring to equation 5, when the motion vector of the nth candidate and the i-th motion vector field are the same, a predefined value ∂ may be output. The value of ∂ may be a positive real number or integer. On the other hand, when the motion vector of the n-th candidate and the i-th motion vector field are not the same, a predefined value 0 may be output. Similarly, referring to equation 6, when the motion vector of the n-th candidate and the j-th motion vector field are the same, a predefined value ∂ may be output. The value of ∂ may be a positive real number or integer. On the other hand, when the motion vector of the n-th candidate and the j-th motion vector field are not the same, a predefined value 0 may be output.

Alternatively, eqₓ(mvpₙ,mvfᵢ) and eq_{y}(mvpₙ,mvfⱼ) of equation 4 may be defined as in the following equations 7 and 8.

$$eq ( {mvp}_{n} , {mvf}_{i} ) = \{ \begin{matrix}\partial , & if ( {mvp}_{n} + offset ) >> shift = ( {mvf}_{i} + offset ) >> shift \\ 0 , & otherwise\end{matrix} , \qquad [ Equation 7 ]$$

$$\begin{matrix}eq ( {mvp}_{n} , {mvf}_{j} ) = \{ \begin{matrix}\partial , & if ( {mvp}_{n} + offset ) >> shift = ( {mvf}_{j} + offset ) >> shift \\ 0 , & otherwise\end{matrix} , & [ Equation 8 ]\end{matrix}$$

Referring to equation 7, when the motion vector of the n-th candidate and the i-th motion vector field are the same within a pre-defined precision, a pre-defined value ∂ may be output. Otherwise, a pre-defined value 0 may be output. The value of ∂ may be a positive real number or integer. Similarly, referring to equation 8, when the motion vector of the n-th candidate and the j-th motion vector field are the same within a pre-defined precision, a pre-defined value ∂ may be output. Otherwise, a pre-defined value 0 may be output. In equations 7 and 8, shift is an integer such as 1, 2, 3, or 4, and shift may be variable based on the size of the block. Offset is a round offset according to the shift, and may be an integer having a value such as 1, 2, 4, or 8 based on the shift.

When a motion information-based calculation method is used, a candidate with a large cost may have similar motion information to the current block. It is advantageous from an encoding perspective to assign a small candidate index to such a candidate. Accordingly, the candidates may be reordered in descending order of the calculated costs.

At least one of the above-described cost calculation methods may be selectively used based on coding information on the current block. Here, the coding information may include at least one of the size of the current block, whether the current block is a block coded in a sub-block mode, motion information of a candidate belonging to the candidate list, whether weighted prediction is applied to the current block, or whether scaling (or resampling) for resolution adjustment is performed on the reference block. Here, the size of the current block may be defined as a width, height, maximum or minimum value of width and height, sum of width and height, or product of width and height of the current block. This may be applied equally to the embodiments described later. When the condition based on the above-mentioned coding information is satisfied, the cost may be calculated based on bilateral matching, and otherwise, the cost may be calculated based on template matching.

At least one of the above-described cost calculation methods may be selectively used based on whether the current block satisfies the block size condition. When the current block satisfies the block size condition, the cost may be calculated based on bilateral matching. On the other hand, when the current block does not satisfy the block size condition, the cost may be calculated based on template matching.

For example, when the size of the current block is less than a threshold, the cost may be calculated based on bilateral matching. On the other hand, when the size of the current block is greater than or equal to the threshold, the cost may be calculated based on template matching.

When the size of the current block is defined as the width or height of the current block, the threshold may be an integer of 8, 16, 32, or more. When the size of the current block is defined as the product of the width and height of the current block, the threshold may be an integer of 64, 128, 256, or more.

For example, when the product of the width and height of the current block is less than 128, the cost may be calculated based on bilateral matching. On the other hand, when the product of the width and height of the current block is greater than or equal to 128, the cost may be calculated based on template matching.

For example, when the size of the current block is greater than a threshold, the cost may be calculated based on bilateral matching. On the other hand, when the size of the current block is less than or equal to a threshold, the cost may be calculated based on template matching.

When the size of the current block is defined as the width or height of the current block, the threshold may be an integer of 8, 16, 32 or more. When the size of the current block is defined as the product of the width and height of the current block, the threshold may be an integer of 64, 128, 256 or more.

For example, when the product of the width and height of the current block is greater than 128, the cost may be calculated based on bilateral matching. On the other hand, when the product of the width and height of the current block is less than or equal to 128, the cost may be calculated based on template matching.

At least one of the above-described cost calculation methods may be selectively used based on whether the candidate of the current block satisfies the above-described bidirectional prediction condition. Here, the bidirectional prediction condition may include at least one of Conditions 1 to 5, as described above, and a detailed description thereof will be omitted here.

For example, when the candidate of the current block satisfies the bidirectional prediction condition, the cost may be calculated for the candidate based on bilateral matching. On the other hand, when the candidate of the current block does not satisfy the bidirectional prediction condition, the cost may be calculated for the candidate based on template matching.

At least one of the above-described cost calculation methods may be selectively used based on whether the current block is a block coded in the sub-block mode. The sub-block mode may refer to a mode in which the current block is divided into a plurality of sub-blocks and inter prediction is performed in units of sub-blocks. When the current block is coded in the sub-block mode, the current block may be divided into sub-blocks having a predetermined size, and each sub-block may be decoded using different motion information. Here, different motion information may mean that at least one of a motion vector, a reference picture index, inter prediction direction information, or weight information for bidirectional weighted prediction is different. For example, a plurality of sub-blocks may share the same reference picture index or inter prediction direction information, but may have different motion vectors or weight information. The size of the sub-block may be a pre-defined fixed size, such as 4×4, 8×8, or 16×16, or may be variably determined based on the size of the current block.

For example, when the current block is a block coded in the sub-block mode, the cost may be calculated based on bilateral matching. On the other hand, when the current block is not a block coded in the sub-block mode, the cost may be calculated based on template matching.

At least one of the above-described cost calculation methods may be selectively used based on position information of the current block. Specifically, when the current block exists at a position where the template area of the current block and/or the reference block is not configured (or, at a position where the template area of the current block and/or the reference block does not exist), the cost may be calculated based on bilateral matching, and otherwise, the cost may be calculated based on template matching.

The case that the current block exists in a position where the template area of the current block and/or reference block is not configured may mean the case that the boundary of the current block is located at or adjacent to the boundary of a picture, slice, tile, virtual pipeline decoding unit (VPDU), coding tree unit (CTU) row, or CTU.

At least one of the above-described cost calculation methods may be selectively used based on at least two of whether the current block satisfies the block size condition, whether a candidate of the current block satisfies the bidirectional prediction condition, whether the current block is a block coded in sub-block mode, or position information of the current block.

For example, when the current block satisfies the block size condition and the candidate of the current block satisfies the bidirectional prediction condition, the cost may be calculated based on bilateral matching. When the current block satisfies the block size condition but the candidate of the current block does not satisfy the bidirectional prediction condition, the cost may be calculated based on template matching. When the current block does not satisfy the block size condition, the cost may be calculated based on template matching. When the current block does not satisfy the block size condition, the cost may be calculated based on template matching regardless of whether the candidate of the current block satisfies the bidirectional prediction condition.

For example, when the current block is a block coded in the sub-block mode and a candidate of the current block satisfies the bidirectional prediction condition, the cost may be calculated based on bilateral matching. When the current block is a block coded in the sub-block mode but the candidate of the current block does not satisfy the bidirectional prediction condition, the cost may be calculated based on template matching. When the current block is not a block coded in the sub-block mode, the cost may be calculated based on template matching. When the current block is not a block coded in the sub-block mode, the cost may be calculated based on template matching regardless of whether the candidate of the current block satisfies the bidirectional prediction condition.

For example, in case that the current block satisfies the block size condition or is a block coded in the sub-block mode, when a candidate of the current block satisfies the bidirectional prediction condition, the cost may be calculated based on bilateral matching. In case that the current block satisfies the block size condition or is a block coded in the sub-block mode, when the candidate of the current block does not satisfy the bidirectional prediction condition, the cost may be calculated based on template matching. When the current block does not satisfy the block size condition and is not a block coded in the sub-block mode, the cost may be calculated based on template matching. When the current block does not satisfy the block size condition and is not a block coded in the sub-block mode, the cost may be calculated based on template matching regardless of whether the candidate of the current block satisfies the bidirectional prediction condition.

For example, when the current block exists at a position where the template area of the current block and/or the reference block is not configured, a bilateral matching-based calculation method may be adaptively used based on whether the candidate of the current block satisfies the bidirectional prediction condition.

For example, in case that the current block exists at a position where the template area of the current block and/or the reference block is not configured, when the candidate of the current block satisfies the bidirectional prediction condition, the cost may be calculated based on the bilateral matching, and when the candidate of the current block does not satisfy the bidirectional prediction condition, the candidate list of the current block may not be reordered.

On the other hand, when the current block exists at a position where the template area of the current block and/or the reference block could be configured, one of a bilateral matching-based calculation method or a template matching-based calculation method may be adaptively used based on at least one of whether the current block satisfies a block size condition, whether the current block is a block coded in a sub-block mode, or whether a candidate of the current block satisfies a bidirectional prediction condition.

For example, in case that the current block exists at a position where the template area of the current block and/or reference block could be configured, when the current block satisfies a block size condition or is a block coded in sub-block mode and a candidate of the current block satisfies a bidirectional prediction condition, the cost may be calculated based on bilateral matching.

However, in case that the current block exists at a position where the template area of the current block and/or reference block could be configured, when the candidate of the current block does not satisfy the bidirectional prediction condition, the cost may be calculated based on template matching even if the current block satisfies the block size condition or is a block coded in sub-block mode.

Even if the current block exists at a position where the template area of the current block and/or the reference block could be configured, when the current block does not satisfy the block size condition and is not a block coded in the sub-block mode, the cost may be calculated based on template matching. Even if the current block exists at a position where the template area of the current block and/or the reference block could be configured, when the current block does not satisfy the block size condition and is not a block coded in the sub-block mode, the cost may be calculated based on template matching regardless of whether a candidate of the current block satisfies the bidirectional prediction condition.

In the case where one of the above-described cost calculation methods is selectively used for each of the candidates in the candidate list, the costs of the candidates may be calculated based on different cost calculation methods. That is, the cost of one of the candidates may be calculated based on template matching, and the cost of another of the candidates may be calculated based on bilateral matching. In this case, normalization may be performed on the calculated costs, and the candidate list may be reordered based on the normalized costs.

For example, when the cost is calculated based on template matching, the cost may be normalized based on the number of pixels belonging to the template area of the current block or reference block. When the cost is calculated based on bilateral matching, the cost may be normalized based on the number of pixels belonging to the L0 reference block or the L1 reference block.

The cost may be calculated using all pixels in the target block. Alternatively, the cost may be calculated using some pixels in the target block, thereby reducing the complexity of cost calculation. Here, the target block may mean a template area of a current block and/or a reference block used for cost calculation based on template matching. Alternatively, the target block may mean an L0/L1 reference block used for cost calculation based on bilateral matching.

Some pixels of the target block may be determined as pixels belonging to a sub-sampled pixel column in the target block.

For example, the sub-sampled pixel column may mean a set of even-numbered pixel columns. Assuming that the coordinate of the top-left pixel of the target block is (x, y), the set of even-numbered pixel columns may include at least one of a 0th pixel column including a pixel of (x, y), a 2nd pixel column including a pixel of (x, y+2), or a 4th pixel column including a pixel of (x, y+4). Alternatively, by increasing the unit of sub-sampling, a set of even-numbered pixel columns including at least one of a 0th pixel column including a pixel of (x, y), a 4th pixel column including a pixel of (x, y+4), or an 8th pixel column including a pixel of (x, y+8) may be used.

For example, the sub-sampled pixel column may mean a set of odd-numbered pixel columns. Assuming that the coordinate of the top-left pixel of the target block is (x, y), the set of odd-numbered pixel columns may include at least one of a 1st pixel column including a pixel of (x, y+1), a 3rd pixel column including a pixel of (x, y+3), or a 5th pixel column including a pixel of (x, y+5). Alternatively, by increasing the unit of sub-sampling, a set of odd-numbered pixel columns including at least one of a 1st pixel column including a pixel of (x, y+1), a 5th pixel column including a pixel of (x, y+5), or a 9th pixel column including a pixel of (x, y+9) may be used.

The above-described embodiment uses pixel columns within the target block, but is not limited thereto, and of course, pixel rows may be used instead of pixel columns within the target block.

Some pixels of the target block may be determined as pixels belonging to a sub-sampled pixel column and a sub-sampled pixel row within the target block. For example, some pixels of the target block may be determined as a set of pixels belonging to a sub-sampled pixel column and pixels belonging to a sub-sampled pixel row within the target block. Alternatively, some pixels of the target block may be determined as pixels belonging to a sub-sampled pixel row while belonging to a sub-sampled pixel column within the target block. The sub-sampled pixel column and the sub-sampled pixel row are as described above, and a duplicate description thereof will be omitted herein.

Some pixels of the target block may be determined as pixels belonging to a sub-sampled sub-block within the target block. For example, the sub-sampled sub-block may mean a set of sub-blocks having even scan indices according to a predetermined scan order. Alternatively, the sub-sampled sub-block may mean a set of sub-blocks having odd scan orders according to a predetermined scan order. Here, the scan order may be any one of a raster scan order, a diagonal scan order, a horizontal scan order, or a vertical scan order.

Some pixels of the target block may be determined as pixels belonging to some sub-blocks among the sub-sampled sub-blocks. For example, some pixels of the target block may mean pixels belonging to the top N sub-blocks in ascending order of scan indexes for the sub-sampled sub-blocks. Here, N may be an integer of 1, 2, 3, 4, or more.

The target block may be divided into a plurality of sub-blocks having a predetermined size. In this case, some pixels of the target block may be determined as pixels belonging to the top N sub-blocks in ascending order of scan indexes according to a predetermined scan order among the sub-blocks in the target block. Here, N may be an integer of 1, 2, 3, 4, or more.

Alternatively, some pixels of the target block may be determined as pixels belonging to a sub-block located in a specific direction among the sub-blocks in the target block. Here, the specific direction may mean the top-left direction, the left direction, or the top direction.

Some pixels of the target block may be determined by a combination of the embodiment relating to the sub-sampled pixel columns and/or pixel rows described above and the embodiment relating to the sub-sampled sub-blocks described above. That is, some pixels of the target block may be determined as pixels belonging to the sub-sampled pixel columns and/or pixel rows within the sub-blocks according to the embodiments described above.

The cost for reordering the candidate list may be calculated for all candidates in the candidate list, or may be calculated for some candidates in the candidate list. For example, the some candidates may be limited to the top M candidates in ascending order of the candidate indices assigned to the candidate list. Here, M may be an integer of 2, 3, 4, or more. The value of M may be a predefined value regardless of the maximum number of candidates to be included in the candidate list. Alternatively, the some candidates may be limited to a spatial candidate and/or a temporal candidate among the candidates in the candidate list. In this way, by calculating the cost only for some candidates, not all candidates in the candidate list, the complexity of calculating the cost for reordering the candidate list may be reduced.

Whether to calculate the cost for all candidates in the candidate list may be determined based on whether the maximum number of candidates to be included in the candidate list is less than a predetermined threshold number. Here, the threshold number may be an integer of 4, 5, 6, 7, 8, or more. For example, when the maximum number of candidates to be included in the candidate list is less than or equal to the threshold number, the cost is calculated for all candidates in the candidate list. Otherwise, the cost may be calculated for some candidates described above.

Referring to FIG. 4, the motion information of the current block may be derived based on the candidate list and candidate index (S420).

The candidate index may mean information coded to predict/derive the motion information of the current block. The candidate index may specify one or more of the plurality of candidates belonging to the candidate list.

The motion vector of the motion information may mean a motion vector in block units. Alternatively, when the current block is a block coded in a sub-block mode, the motion vector of the motion information may mean a motion vector derived in sub-block units of the current block. For this purpose, as described above, the current block may be divided into a plurality of N×M sub-blocks. Here, the N×M sub-block may have a rectangular (N>M or N<M) or square (N=M) shape. The values of N and M may be 2, 4, 8, 16, 32, or more.

Referring to FIG. 4, inter prediction may be performed on the current block based on the derived motion information (S430).

Specifically, the reference block may be specified using the motion information of the current block. When the motion information of the current block is motion information for bidirectional prediction, the reference block may be specified for each of the L0 direction and the L1 direction.

When the current block is a block coded in sub-block mode, the reference block may be specified for each sub-block of the current block. The reference block of each sub-block may belong to one reference picture. That is, the sub-blocks belonging to the current block may share one reference picture. Alternatively, the reference picture indices may be set independently for each sub-block of the current block.

The prediction block of the current block may be generated based on the specified reference block.

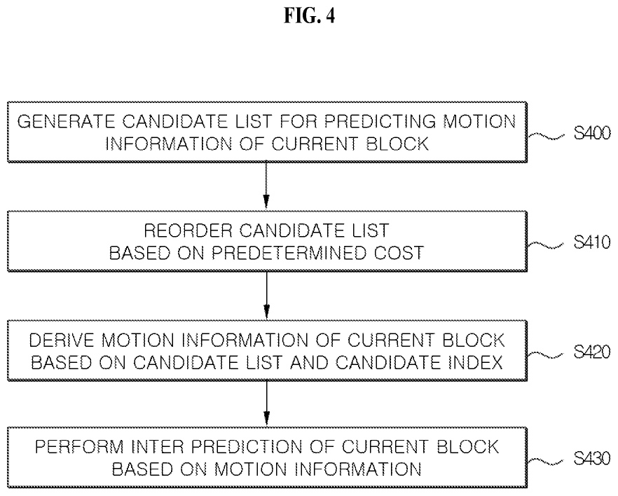

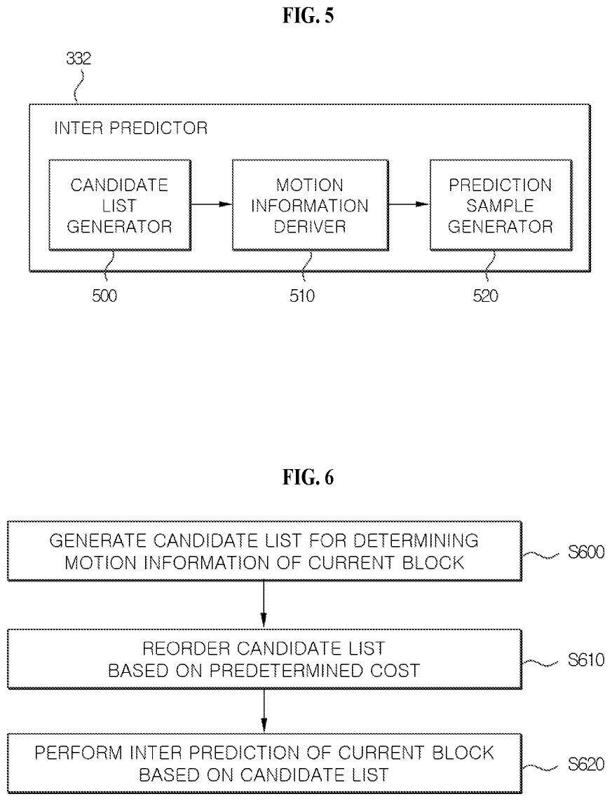

FIG. 5 illustrates a schematic configuration of an inter predictor (332) that performs an inter prediction method according to the present disclosure.

The inter prediction method performed in the decoding apparatus is described with reference to FIG. 4. This may be performed in the same manner in the inter predictor (332) of the decoding apparatus, and a detailed description thereof will be omitted below.

Referring to FIG. 5, the inter predictor (332) may include a candidate list generator (500), a motion information deriver (510), and a prediction sample generator (520).

The candidate list generator (500) may generate a candidate list for predicting/deriving motion information of the current block. The candidate list may be for the merge mode or the AMVP mode, or may be for the affine merge mode or the affine inter mode. The motion information may include at least one of a motion vector, a reference picture index, inter prediction direction information, or weight information for bidirectional weighted prediction.

The candidate list generator (500) may derive a plurality of candidates including at least one of a spatial candidate or a temporal candidate, and generate a candidate list based on the plurality of candidates.

The candidate list generator (500) may reorder one or more candidates in the candidate list based on a predetermined cost. That is, a cost may be calculated for each candidate in the candidate list, and the candidates may be reordered in ascending or descending order of the calculated costs to generate a final candidate list.

The candidate list generator (500) may calculate the cost for reordering the candidate list by using at least one of a template matching (TM)-based calculation method, a bilateral matching (BM)-based calculation method, or a motion information-based calculation method, as described with reference to FIG. 4.

The candidate list generator (500) may calculate the cost for reordering the candidate list by selecting at least one of the above-described cost calculation methods based on the coding information on the current block. For example, at least one of the above-described cost calculation methods may be selectively used based on at least one of whether the current block satisfies the block size condition, whether the candidate of the current block satisfies the bidirectional prediction condition, whether the current block is a block coded in a sub-block mode, or the position information of the current block, as described with reference to FIG. 4.

When one of the above-described cost calculation methods is selectively used for each of the candidates in the candidate list, the costs of the candidates may be calculated based on different cost calculation methods. In this case, the candidate list generator (500) may perform normalization on the calculated costs and reorder the candidate list based on the normalized costs.

The cost for reordering the candidate list may be calculated using all pixels of the target block to be used for cost calculation. Alternatively, it may be calculated using some pixels within the target block, and for this purpose, the candidate list generator (500) may determine some pixels within the target block for cost calculation. The method for determining some pixels within the target block is as described in FIG. 4.

As described above, the cost for reordering the candidate list may be calculated for all candidates in the candidate list or for some candidates in the candidate list.

The motion information deriver (510) may derive motion information of the current block based on the candidate list and a candidate index. Here, the candidate index is information encoded to predict/derive motion information of the current block, and may specify one or more candidates among a plurality of candidates in the candidate list.

The motion information deriver (510) may derive a motion vector in block units or may derive a motion vector in sub-block units of the current block when deriving motion information of the current block. In order to derive a motion vector in sub-block units, the motion information deriver (510) may divide the current block into units of N×M sub-blocks. Here, the N×M sub-block may have a rectangular (N>M or N<M) or square (N=M) shape. The values of N and M may be 2, 4, 8, 16, 32, or more.

The prediction sample generator (520) may perform inter prediction based on the motion information obtained from the motion information deriver (510) to generate prediction samples of the current block.

Specifically, the prediction sample generator (520) may specify a reference block using motion information of the current block, and may generate a prediction block of the current block based on the specified reference block.

Alternatively, when a motion vector is derived in units of sub-blocks in the motion information deriver (510), the prediction sample generator (520) may specify a reference block for each sub-block of the current block and generate a prediction block of the current block based on the specified reference blocks. In this case, the specified reference blocks may belong to one reference picture. Alternatively, a reference picture indices may be set independently for each sub-block of the current block, and in this case, one of the specified reference blocks may belong to a different reference picture from the other.

FIG. 6 illustrates an inter prediction method performed by an encoding apparatus as an embodiment according to the present disclosure.

Referring to FIG. 6, a candidate list for determining motion information of the current block may be generated (S600).

The motion information may include at least one of a motion vector, a reference picture index, inter prediction direction information, or weight information for bidirectional weighted prediction. The candidate list may be for a merge mode or an AMVP mode, or may be for an affine merge mode or an affine inter mode.

A plurality of candidates including at least one of a spatial candidate or a temporal candidate may be derived, and a candidate list may be generated based on the derived plurality of candidates.

Referring to FIG. 6, one or more candidates in the candidate list may be reordered based on a predetermined cost (S610).

The reordering according to the present disclosure may refer to changing the position of a candidate in the candidate list or changing the candidate index assigned to the candidate. To this end, a cost for reordering may be calculated for each candidate in the candidate list. The candidates may be reordered in ascending or descending order of the calculated costs to generate a final candidate list.

The cost according to the present disclosure may be calculated using at least one of a template matching (TM)-based calculation method, a bilateral matching (BM)-based calculation method, or a motion information-based calculation method. This is as described with reference to FIG. 4.

In addition, at least one of the above-described cost calculation methods may be selectively used based on coding information on the current block to calculate the cost for reordering the candidate list. For example, at least one of the above-described cost calculation methods may be selectively used based on at least one of whether the current block satisfies the block size condition, whether the candidate of the current block satisfies the bidirectional prediction condition, whether the current block is a block coded in a sub-block mode, or position information of the current block, as described with reference to FIG. 4.

In the case where one of the above-described cost calculation methods is selectively used for each of the candidates in the candidate list, the costs of the candidates may be calculated based on different cost calculation methods. In this case, normalization may be performed on the calculated costs, and the candidate list may be reordered based on the normalized costs.

The cost for reordering the candidate list may be calculated using all pixels of the target block to be used for cost calculation, or may be calculated using some pixels within the target block. The method for determining some pixels within the target block for cost calculation is as described in FIG. 4.

As described above, the cost for reordering the candidate list may be calculated for all candidates in the candidate list or for some candidates in the candidate list.

Referring to FIG. 6, inter prediction may be performed for the current block based on the candidate list (S620).

The prediction samples of the current block may be generated based on at least one candidate among a plurality of candidates belonging to the candidate list.

Specifically, a reference block may be specified using motion information of an optimal candidate among a plurality of candidates. A prediction block of a current block may be generated based on the specified reference block. When the current block is encoded in a sub-block mode, the reference block may be specified for each sub-block of the current block, and a prediction block of the current block may be generated based on the specified reference blocks. Reference blocks corresponding to the sub-blocks of the current block may belong to one reference picture. Alternatively, the reference picture indices may be set independently for each sub-block of the current block, and in this case, one of the specified reference blocks may belong to a different reference picture from the other.

Among a plurality of candidates belonging to the candidate list, at least one optimal candidate for generating prediction samples of the current block may be determined. A candidate index specifying the determined candidate may be encoded and inserted into a bitstream.

FIG. 7 illustrates a schematic configuration of an inter predictor (221) that performs an inter prediction method according to the present disclosure.

The inter prediction method performed in the encoding apparatus is described with reference to FIG. 6. This may be performed in the same manner in the inter predictor (221) of the encoding apparatus, and a detailed description thereof will be omitted below.

Referring to FIG. 7, the inter predictor (221) may include a candidate list generator (700) and a prediction sample generator (710).

The candidate list generator (700) may generate a candidate list for determining motion information of a current block. The motion information may include at least one of a motion vector, a reference picture index, inter prediction direction information, or weight information for bidirectional weighted prediction. The candidate list may be for a merge mode or an AMVP mode, or for an affine merge mode or an affine inter mode.

The candidate list generator (700) may derive a plurality of candidates including at least one of a spatial candidate or a temporal candidate, and generate a candidate list based on the plurality of candidates.

The candidate list generator (700) may reorder one or more candidates in the candidate list based on a predetermined cost. That is, a cost may be calculated for each candidate in the candidate list, and the candidates are reordered in ascending or descending order of the calculated costs to generate a final candidate list.

The candidate list generator (700) may calculate the cost for reordering the candidate list by using at least one of a template matching (TM)-based calculation method, a bilateral matching (BM)-based calculation method, or a motion information-based calculation method, as described with reference to FIG. 4.

The candidate list generator (700) may calculate the cost for reordering the candidate list by selecting at least one of the above-described cost calculation methods based on the coding information on the current block. For example, at least one of the above-described cost calculation methods may be selectively used based on at least one of whether the current block satisfies the block size condition, whether the candidate of the current block satisfies the bidirectional prediction condition, whether the current block is a block coded in a sub-block mode, or the position information of the current block, as described with reference to FIG. 4.

If one of the above-described cost calculation methods is selectively used for each of the candidates in the candidate list, the costs of the candidates may be calculated based on different cost calculation methods. In this case, the candidate list generator (700) may perform normalization on the calculated costs and reorder the candidate list based on the normalized costs.

The cost for reordering the candidate list may be calculated using all pixels of the target block to be used for cost calculation. Alternatively, it may be calculated using some pixels within the target block, and for this purpose, the candidate list generator (700) may determine some pixels within the target block for cost calculation. The method for determining some pixels within the target block is as described in FIG. 4.

As described above, the cost for reordering the candidate list may be calculated for all candidates in the candidate list or for some candidates in the candidate list.

The prediction sample generator (710) may perform inter prediction on the current block based on the candidate list. The prediction samples of the current block may be generated based on at least one optimal candidate among a plurality of candidates included in the candidate list.

Specifically, the prediction sample generator (710) may specify a reference block using motion information of an optimal candidate among a plurality of candidates, and may generate a prediction block of the current block based on the specified reference block. When the current block is encoded in a sub-block mode, the reference block may be specified for each sub-block of the current block, and the prediction block of the current block may be generated based on the specified reference blocks. In this case, the reference blocks corresponding to the sub-blocks of the current block may belong to one reference picture. Alternatively, the reference picture indices may be set independently for each sub-block of the current block, and in this case, one of the specified reference blocks may belong to a different reference picture from the other.

In addition, the prediction sample generator (710) may further include a motion information determiner (not shown). The motion information determiner may determine at least one candidate for generating prediction samples of the current block from among a plurality of candidates belonging to the candidate list. In this case, the entropy encoder (240) may encode a candidate index that specifies the determined candidate and insert it into the bitstream.dfd

In the above-described embodiment, methods are described based on a flowchart as a series of steps or blocks, but a corresponding embodiment is not limited to the order of steps, and some steps may occur simultaneously or in different order with other steps as described above. In addition, those skilled in the art may understand that steps shown in a flowchart are not exclusive, and that other steps may be included or one or more steps in a flowchart may be deleted without affecting the scope of embodiments of the present disclosure.

The above-described method according to embodiments of the present disclosure may be implemented in a form of software, and an encoding apparatus and/or a decoding apparatus according to the present disclosure may be included in a device which performs image processing such as a TV, a computer, a smartphone, a set top box, a display device, etc.

In the present disclosure, when embodiments are implemented as software, the above-described method may be implemented as a module (a process, a function, etc.) that performs the above-described function. A module may be stored in a memory and may be executed by a processor. A memory may be internal or external to a processor, and may be connected to a processor by a variety of well-known means. A processor may include an application-specific integrated circuit (ASIC), another chipset, a logic circuit and/or a data processing device. A memory may include a read-only memory (ROM), a random access memory (RAM), a flash memory, a memory card, a storage medium and/or another storage device. In other words, embodiments described herein may be performed by being implemented on a processor, a microprocessor, a controller or a chip. For example, functional units shown in each drawing may be performed by being implemented on a computer, a processor, a microprocessor, a controller or a chip. In this case, information for implementation (ex. information on instructions) or an algorithm may be stored in a digital storage medium.

In addition, a decoding apparatus and an encoding apparatus to which embodiment(s) of the present disclosure are applied may be included in a multimedia broadcasting transmission and reception device, a mobile communication terminal, a home cinema video device, a digital cinema video device, a surveillance camera, a video conversation device, a real-time communication device like a video communication, a mobile streaming device, a storage medium, a camcorder, a device for providing video on demand (VOD) service, an over the top video (OTT) device, a device for providing Internet streaming service, a three-dimensional (3D) video device, a virtual reality (VR) device, an argumente reality (AR) device, a video phone video device, a transportation terminal (ex. a vehicle (including an autonomous vehicle) terminal, an airplane terminal, a ship terminal, etc.) and a medical video device, etc., and may be used to process a video signal or a data signal. For example, an over the top video (OTT) device may include a game console, a blu-ray player, an Internet-connected TV, a home theater system, a smartphone, a tablet PC, a digital video recorder (DVR), etc.

In addition, a processing method to which embodiment(s) of the present disclosure are applied may be produced in a form of a program executed by a computer and may be stored in a computer-readable recording medium. Multimedia data having a data structure according to embodiment(s) of the present disclosure may be also stored in a computer-readable recording medium. The computer-readable recording medium includes all types of storage devices and distributed storage devices that store computer-readable data. The computer-readable recording medium may include, for example, a blu-ray disk (BD), an universal serial bus (USB), ROM, PROM, EPROM, EEPROM, RAM, CD-ROM, a magnetic tape, a floppy disk and an optical media storage device. In addition, the computer-readable recording medium includes media implemented in a form of a carrier wave (e.g., transmission via the Internet). In addition, a bitstream generated by an encoding method may be stored in a computer-readable recording medium or may be transmitted through a wired or wireless communication network.

In addition, embodiment(s) of the present disclosure may be implemented by a computer program product by a program code, and the program code may be executed on a computer by embodiment(s) of the present disclosure. The program code may be stored on a computer-readable carrier.

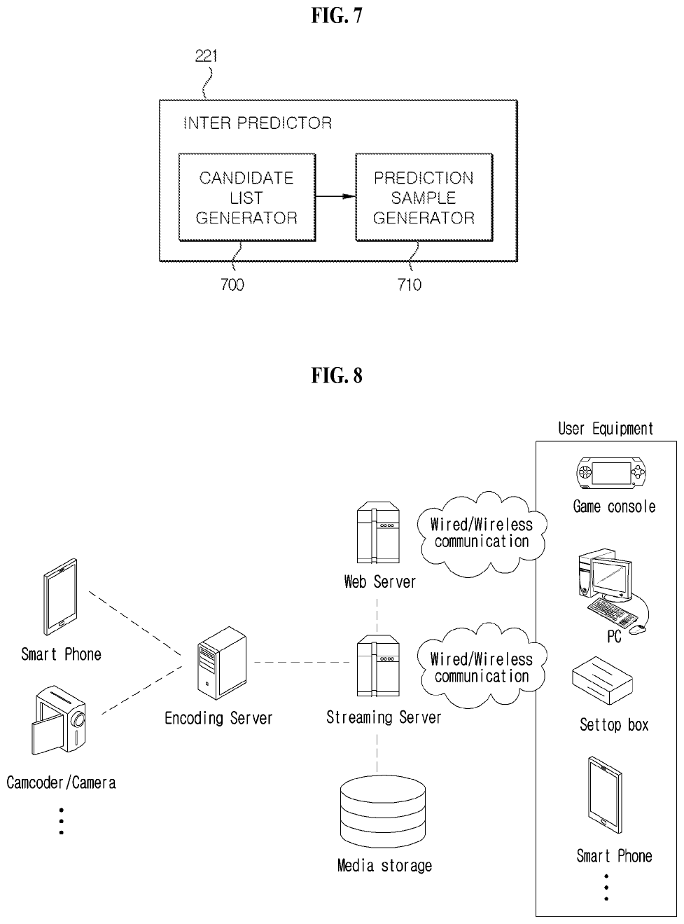

FIG. 8 shows an example of a contents streaming system to which embodiments of the present disclosure may be applied.

Referring to FIG. 8, a contents streaming system to which embodiment(s) of the present disclosure are applied may largely include an encoding server, a streaming server, a web server, a media storage, a user device and a multimedia input device.

The encoding server generates a bitstream by compressing contents input from multimedia input devices such as a smartphone, a camera, a camcorder, etc. into digital data and transmits it to the streaming server. As another example, when multimedia input devices such as a smartphone, a camera, a camcorder, etc. directly generate a bitstream, the encoding server may be omitted.

The bitstream may be generated by an encoding method or a bitstream generation method to which embodiment(s) of the present disclosure are applied, and the streaming server may temporarily store the bitstream in a process of transmitting or receiving the bitstream.

The streaming server transmits multimedia data to a user device based on a user's request through a web server, and the web server serves as a medium to inform a user of what service is available. When a user requests desired service from the web server, the web server delivers it to a streaming server, and the streaming server transmits multimedia data to a user. In this case, the contents streaming system may include a separate control server, and in this case, the control server controls a command/a response between each device in the content streaming system.

The streaming server may receive contents from a media storage and/or an encoding server. For example, when contents is received from the encoding server, the contents may be received in real time. In this case, in order to provide smooth streaming service, the streaming server may store the bitstream for a certain period of time.

An example of the user device may include a mobile phone, a smart phone, a laptop computer, a digital broadcasting terminal, a personal digital assistants (PDAs), a portable multimedia players (PMP), a navigation, a slate PC, a Tablet PC, an ultrabook, a wearable device (e.g., a smartwatch, a smart glass, a head mounted display (HMD), a digital TV, a desktop, a digital signage, etc.

Each server in the contents streaming system may be operated as a distributed server, and in this case, data received from each server may be distributed and processed.

The claims set forth herein may be combined in various ways. For example, a technical characteristic of a method claim of the present disclosure may be combined and implemented as a device, and a technical characteristic of a device claim of the present disclosure may be combined and implemented as a method. In addition, a technical characteristic of a method claim of the present disclosure and a technical characteristic of a device claim may be combined and implemented as a device, and a technical characteristic of a method claim of the present disclosure and a technical characteristic of a device claim may be combined and implemented as a method.

1. An image decoding method, comprising:
generating a candidate list of a current block;
reordering one or more candidates in the candidate list based on a predetermined cost, the cost being calculated for each of a plurality of candidates in the candidate list based on at least one of a template matching-based calculation method or a bilateral matching-based calculation method;
deriving motion information of the current block based on the candidate list and a candidate index; and
performing inter prediction for the current block based on the motion information.

2. The image decoding method of claim 1, wherein one of the template matching-based calculation method or the bilateral matching-based calculation method is selectively used based on whether the current block satisfies a block size condition.

3. The image decoding method of claim 1, wherein one of the template matching-based calculation method or the bilateral matching-based calculation method is selectively used based on whether a candidate belonging to the candidate list satisfies a bidirectional prediction condition, and
wherein the bidirectional prediction condition includes at least one of a first condition that motion information of the candidate is motion information for bidirectional prediction, a second condition that one of an L0 reference picture or an L1 reference picture temporally precedes a current picture, and the other temporally follows the current picture, a third condition that a temporal distance between the current picture and the L0 reference picture is the same as a temporal distance between the current picture and the L1 reference picture, a fourth condition that the L0 and L1 reference pictures of the candidate use weighted prediction, or a fifth condition that the L0 and L1 reference pictures of the candidate have the same size as the current picture.

4. The image decoding method of claim 1, wherein one of the template matching-based calculation method or the bilateral matching-based calculation method is selectively used based on whether the current block is a block coded in a sub-block mode.

5. The image decoding method of claim 1, wherein one of the template matching-based calculation method or the bilateral matching-based calculation method is selectively used based on position information of the current block.

6. The image decoding method of claim 1, wherein one of the template matching-based calculation method or the bilateral matching-based calculation method is selectively used based on at least two of whether the current block satisfies a block size condition, whether a candidate of the candidate list satisfies a bidirectional prediction condition, whether the current block is a block coded in a sub-block mode, or position information of the current block.

7. The image decoding method of claim 6, wherein when the current block satisfies the block size condition and the candidate in the candidate list satisfies the bidirectional prediction condition, the cost is calculated using the bilateral matching-based calculation method.

8. The image decoding method of claim 6, wherein when the current block is coded in the sub-block mode and the candidate satisfies the bidirectional prediction condition, the cost is calculated using the bilateral matching-based calculation method.

9. The image decoding method of claim 6, wherein when the current block exists at a position where a template area for the template matching-based calculation method is not configured and the candidate satisfies the bidirectional prediction condition, the cost is calculated using the bilateral matching-based calculation method.

10. The image decoding method of claim 6, wherein the bilateral matching-based calculation method calculates the cost using an L0 reference block and an L1 reference block specified based on motion information of a candidate belonging to the candidate list,
wherein the cost is calculated based on some pixels in the L0 reference block and the L1 reference block, and
wherein the some pixels are determined as a sub-sampled pixel column in the L0 reference block and the L1 reference block, a sub-sampled sub-block in the L0 reference block and the L1 reference block, or a sub-sampled pixel column in the sub-sampled sub-block.

11. An image encoding method, comprising:
generating a candidate list of a current block;
reordering one or more candidates in the candidate list based on a predetermined cost, the cost being calculated for each of a plurality of candidates in the candidate list based on at least one of a template matching-based calculation method or a bilateral matching-based calculation method; and
performing inter prediction for the current block based on the candidate list.

12. A computer-readable storage medium storing a bitstream generated by an image encoding method according to claim 11.

13. A method of transmitting data for image information, comprising:
obtaining a bitstream for the image information, wherein the bitstream is generated by generating a candidate list of a current block, reordering one or more candidates in the candidate list based on a predetermined cost, and performing inter prediction for the current block based on the candidate list; and
transmitting the data including the bitstream,
wherein the cost is calculated for each of a plurality of candidates in the candidate list based on at least one of a template matching-based calculation method or a bilateral matching-based calculation method.
